(19) United States
(12) Patent Application Publication
(10) Pub. No.: US 2025/0291294 A1
(43) Pub. Date: Sep. 18, 2025

(54) METHOD AND APPARATUS FOR CONVERTING LUMINANCE INFORMATION INTO DENSITY INFORMATION

(71) Applicant: CANON KABUSHIKI KAISHA, Tokyo (JP)

(72) Inventors: SHOHEI OKUMURA, Tokyo (JP); AKIHITO YOKOTE, Chiba (JP); MIREI AOYAMA, Chiba (JP); HIROAKI ISHIDA, Tokyo (JP); TATSUOMI MURAYAMA, Chiba (JP); TADASHI FUKUDA, Tokyo (JP); TAKENORI SUEOKA, Ibaraki (JP)

(21) Appl. No.: 19/073,470

(22) Filed: Mar. 7, 2025

(30) Foreign Application Priority Data
Mar. 18, 2024 (JP) 2024-042783
Jan. 23, 2025 (JP) 2025-009977

(51) Int. Cl. G03G 15/00; G06K 15/02; G06K 15/14

(52) U.S. Cl. CPC G03G 15/5062; G06K 15/027; G06K 15/14

(57) ABSTRACT

An apparatus forms a test image for a first density calibration, amplifies a first signal from a sensor based on a result of receiving a reflected light from a test image for the first density calibration, and performs the first density calibration based on the amplified first signal by an amplifier. The apparatus forms a test image for a second density calibration, amplifies a second signal from the sensor based on a result of receiving a reflected light from the test image for the second density calibration, and performs the second density calibration based on the amplified second signal by the amplifier. A gain of the second signal is higher than that of the first signal.

### BACKGROUND OF THE INVENTION

### Field of the Invention

The present invention relates to a method and an apparatus for converting luminance information into density information.

### Description of the Related Art

An image forming apparatus converts a sensor output (luminance signal) value outputted from a sensor of a reading apparatus into a density signal by reading a document by the reading apparatus, and forms an image on a sheet based on the density signal (US-2001-0046060). An image forming apparatus in which toner of differing particle diameters is supplied to a developing device, converts a result (measured value) obtained by measuring a measurement image for density control by a measuring unit to a density value based on a conversion characteristic selected according to the average particle diameter of the toner in the developing device from among a plurality of conversion characteristic (Japanese Patent Laid-Open No. 2019-101302).

A conversion unit that converts an input signal into an output signal has a limit on a data size that can be outputted. For example, a conversion unit capable of outputting an 8-bit output signal (for example, a density signal) can output an output signal only in 256 levels from 0 to 255. This means that when the scope of the output signal value is widened, the resolution is decreased, and when the resolution is increased, the range of the output signal value that can be outputted is narrowed.

In order to correct a tone characteristic of an image to be formed by an image forming apparatus, a conversion unit must be able to obtain a density signal of a wide range of measurement images from low density to high density. In a conventional image forming apparatus, the density signal of the measurement image is always obtained under the same condition regardless of the density of the measurement image. The conventional image forming apparatus uses conditions in order to detect a tone characteristic so as to measure a measurement image from low density to high density. However, a density detection range of a measurement image for detecting density unevenness is narrower than that of the measurement image for detecting the tone characteristic (the measurement image from the low density to the high density). If the density unevenness is to be detected, a density signal should be obtained at a high resolution in this narrow density range (a specific density range). Therefore, the conventional image forming apparatus is not possible to detect the density unevenness with high accuracy.

### SUMMARY OF THE INVENTION

The present disclosure provides an image forming apparatus comprising: an image forming unit configured to form an image; a sensor configured to receive reflected light from a test image formed by the image forming unit and output a signal based on a result of receiving the reflected light from the test image; an amplifier configured to amplify the signal outputted from the sensor based on a gain; and a controller configured to: control the image forming unit to form a test image for a first density calibration, control the amplifier to amplify a first signal outputted by the sensor, the first signal based on a result of receiving a reflected light from the test image for the first density calibration, and perform the first density calibration based on the amplified first signal by the amplifier; and control the image forming unit to form a test image for a second density calibration, control the amplifier to amplify a second signal outputted by the sensor, the second signal based on a result of receiving a reflected light from the test image for the second density calibration, and perform the second density calibration based on the amplified second signal by the amplifier, wherein a gain of the second signal is higher than a gain of the first signal.

Further features of the present invention will become apparent from the following description of exemplary embodiments with reference to the attached drawings.

### BRIEF DESCRIPTION OF THE DRAWINGS

FIG. 1 is a diagram illustrating an image forming system.

FIG. 2 is a diagram illustrating a control system and an image processing system.

FIG. 3 is a diagram illustrating a relationship between a process color and a channel of a scanned image.

FIGS. 4A and 4B are diagrams illustrating a luminance-density conversion table.

FIGS. 5A and 5B are enlarged views illustrating the luminance-density conversion table.

FIG. 6 is a diagram illustrating functions of a CPU.

FIG. 7 is a diagram illustrating a menu screen.

FIGS. 8A and 8B diagrams illustrating test patterns.

FIG. 9 is a flowchart illustrating a method of creating a tone correction table.

FIG. 10 is a flowchart illustrating a method of creating a correction value for correcting density unevenness.

FIG. 11 is a diagram illustrating the image forming system.

FIG. 12 is a diagram illustrating the control system and the image processing system.

FIG. 13 is a diagram illustrating functions of a CPU.

FIG. 14 is a diagram illustrating a test pattern.

FIG. 15 is a flowchart illustrating a method of creating a tone correction table.

FIG. 16 is a flowchart illustrating a method of creating a correction value for correcting density unevenness.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### 1. Embodiment 1

### 1-1. Image Forming System

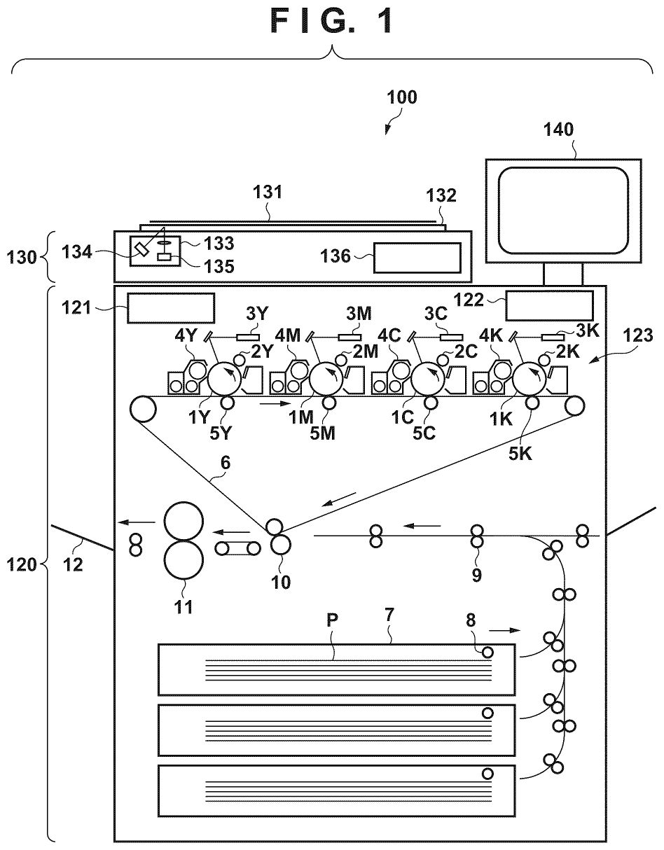

As shown in FIG. 1, a copying machine 100 is an exemplary image forming system. The copying machine 100 includes a image forming apparatus (hereinafter referred to as a printer) 120, an image processing apparatus 122, a reading apparatus (hereinafter referred to as a reader) 130, and an operation unit

### 1-2. Printer

The printer 120 is an electrophotographic image forming apparatus that forms full-color images using yellow, magenta, cyan, and black toners (Y, M, C, and K). An image forming unit 123 is called an image forming engine, and forms a toner image on a sheet P. A printer control unit 121 receives raster image data through the image processing apparatus 122, and controls the image forming unit 123 to form a toner image corresponding to the raster image data on a sheet P. Various components forming the image forming unit 123 are given reference numerals in FIG. 1. The characters YMCK are assigned to the respective reference numerals. When matters common to the four colors are described, the characters YMCK are omitted from the reference numerals.

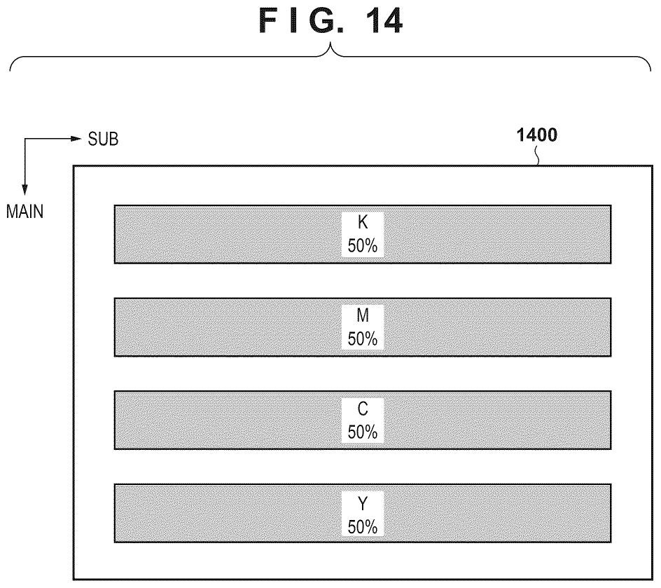

A photosensitive drum 1 is an image carrier that is driven and rotated by a motor M1 shown in FIG. 14. A charging roller 2 uniformly charges a surface of the rotating photosensitive drum 1. Instead of the charging roller 2, another charging member such as a charging wire may be employed. An exposure device 3 exposes the surface of the photosensitive drum 1 on the basis of an image signal supplied from the printer control unit 121 or the image processing apparatus 122 to form an electrostatic latent image. A developing roller 4 is called a developing sleeve, and develops the electrostatic latent image using the toner held in a toner container to form toner images. A primary transfer roller 5 faces the photosensitive drum 1 via an intermediate transfer belt 6. The primary transfer roller 5 transfers the toner images from the photosensitive drum 1 to the intermediate transfer belt 6. The primary transfer roller 5 may be replaced by a transfer member called a transfer blade. A Y color toner image, an M color toner image, a C color toner image, and a K color toner image are sequentially transferred to the intermediate transfer belt 6 to form a full-color image.

A sheet cassette 7 is a sheet storage for storing a plurality of sheets P. A feeding roller 8 feeds the sheet P from the sheet cassette 7. A plurality of conveyance rollers 9 provided in a conveyance path convey the sheet P to a secondary transfer nip. The secondary transfer nip is formed by abutting the intermediate transfer belt 6 and s secondary transfer roller 10.

The secondary transfer roller 10 transfers the toner images from the intermediate transfer belt 6 to the sheet P. The fixing device 11 includes a heating film and a pressure roller. The sheet P passes through a fixing nip formed by the heating film and the pressure roller. As a result, the sheet P and the toner image are subjected to heat and pressure, and the toner image is fixed on the sheet P. Thereafter, the sheet P is discharged to a sheet tray 12.

### 1-3. Reader

The reader 130 includes a document table 132, a reading unit 133, and an image processing unit 136. The document table 132 is a flat glass plate having a light-transmitting property. The reading unit 133 irradiates a document 131 with light from a light emitting element 134, which is an illumination light source, and receives a reflected light from the document 131 by a light receiving element 135. The light emitting element 134 is, for example, a light emitting diode. The light receiving element 135 is, for example, a line sensor with RGB color filters. The light receiving element 135 separates the reflected light from the document 131 into three color components of RGB by the color filters, receives them, and outputs a luminance signal as a light reception result (a reading result) to the image processing unit 136. The reading unit 133 reads the document 131 while moving relative to the document 131 in a sub-scanning direction of the document 131. Note that the document 131 may be conveyed by an automated document feeder (ADF) while the reading unit 133 is stopped. The image processing unit 136 performs predetermined image processing on the luminance signal output from the light receiving element 135, and outputs the luminance signal to the printer 120. For example, raster image data of red, green, and blue (RGB) is generated by the predetermined image process.

The operation unit 140 includes an input device that receives an instruction input by a user, and a display device that displays information to the user. The input device includes a hardware key, a switch, and a touch sensor. The display device includes, for example, a liquid crystal display.

### 1-4. Control System and Image Processing System

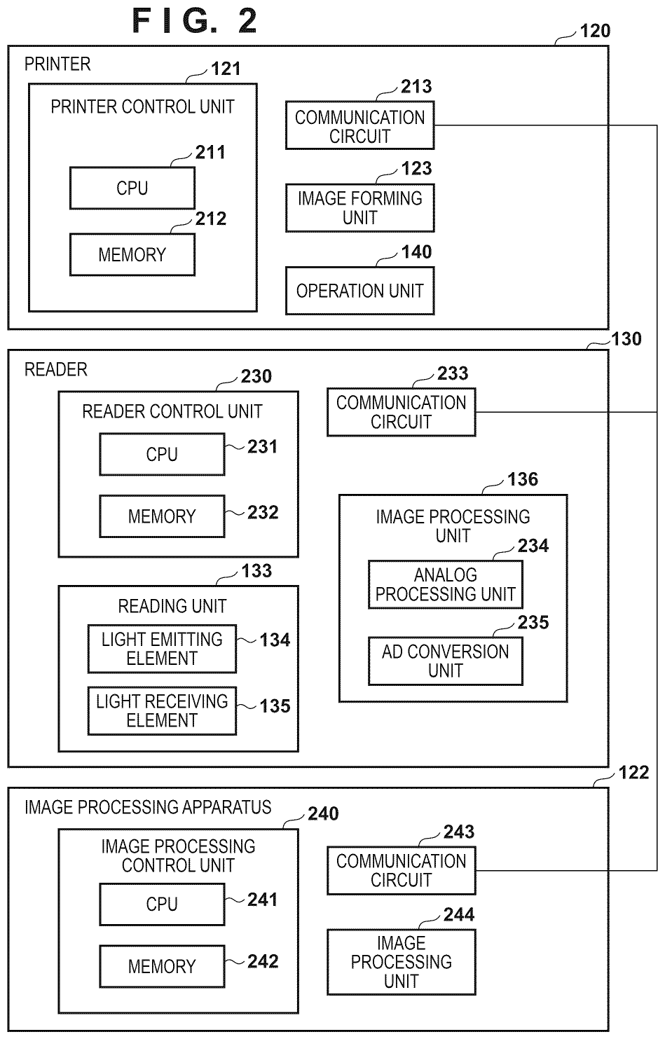

FIG. 2 shows a control system and an image processing system. The printer control unit 121 is a controller that controls the operation of the printer 120. The printer control unit 121 includes a central processing unit (CPU) 211 and a storage device (hereinafter referred to as a memory) 212. The memory 212 includes a read only memory (ROM), a random access memory (RAM), and so on. The printer control unit 121 is connected to the image forming unit 123, the operation unit 140, the communication circuit 213, and the like. The printer control unit 121 is further connected to a drive source (e.g., a motor M1) for operating the printer 120, a sheet sensor, an environmental sensor, a power supply, and the like.

The CPU 211 executes a control program stored in the memory 212, and controls the image forming unit 123 and the like in accordance with the control program. The memory 212 may also store a luminance-density conversion table or the like, which will be described later. The CPU 211 is connected to the reader 130, the image processing apparatus 122, and an external device (host computer) (not shown) via a communication circuit 213 by wire or wirelessly, and performs bidirectional communication.

A reader control unit 230 is a controller including a CPU 231 and a memory 232. The reader control unit 230 communicates with the printer control unit 121 and the image processing apparatus 122 via a communication circuit 233. The CPU 231 executes a control program stored in the memory 232 and controls the reading unit 133 and the image processing unit 136 in accordance with the control program.

The image processing unit 136 includes an analog processing unit 234 and an AD conversion unit 235. The term “AD” is an abbreviation for analog/digital. The analog processing unit 234 performs gain adjustment on an electric signal obtained by the light receiving element 135 in accordance with the gain (e.g., amplification factor) set by the printer control unit 121. The reading unit 133 is an example of a sensor that receives the reflected light from a test image formed by the image forming unit 123 and outputs a signal based on the received result of the reflected light from the test image. The analog processing unit 234 is an example of an amplifier that amplifies a signal output from a sensor. The AD conversion unit 235 generates a digital signal by performing analog-to-digital conversion on an electric signal outputted from the analog processing unit 234. The image processing unit 136 further performs predetermined image processing (e.g., shading correction) on a digital signal to generate a data string of a luminance signal. As a result, two-dimensional RGB luminance data (hereinafter referred to as scanned images) is obtained. The CPU 231 provides scanned images to the printer 120 via the communication circuit 233.

The CPU 231 changes or selects an amount of light of the light emitting element 134 and the gain of the analog processing unit 234 according to the type of the document 131 to be read. For example, when a test pattern for the tone correction is read, the amount of light and the gain are set so that a density of 0 or more and 2.3 or less is converted into a luminance of 0 or more and 255 or less without saturation. Further, for example, when a test pattern for the density unevenness correction is read, the amount of light and the gain are set so that a density of 0.6 or more and 1.4 or less is converted into a luminance of 0 or more and 255 or less without saturation. Here, as the density, a value of a reflection density calculated with a weight factor of ISOstatusA using a spectral reflection densitometer may be used.

The image processing apparatus 122 includes an image processing control unit 240, a communication circuit 243, and an image processing unit 244. The image processing control unit 240 is a controller including a CPU 241 and a memory 242. The CPU 241 executes a control program stored in the memory 242 and controls the image processing unit 244 according to the control program. The CPU 241 performs various image processing on a print job inputted from the external device via the communication circuit 243, and outputs a 1-bit image signal of YMCK to the corresponding exposure device 3Y, 3M, 3C, 3K. The print job includes instructions to the printer 120. The instructions are written, for example, in a Page Description Language (PDL). In addition to print content (document), the print job may include various setting information such as a type of the sheet P, single-sided/double-sided printing, image position adjustment, magnification, rotate, page layout, color processing, character/thin line processing, header/footer addition, and the like. Such a print job is generated by the printer control unit 121 or the external device. In the latter case, the user performs various settings using a user interface on a client device connected to the printer 120 via a network using a driver software or the like. As a result, the print job is generated.

The image processing unit 244 extracts image data from the inputted print job (PDL data) via an interpreter and a renderer. Further, the image processing unit 244 rasterizes the image data in units of planes of the sheet P by raster image data processing (RIP) to generate raster image data which is a set of pixels having a predetermined resolution and a predetermined bit depth. The image processing unit 244 perform a color conversion for converting the raster image data to generate YMCK image signals, and applies tone correction and density unevenness correction to the image signals. Further, the image processing unit 244 converts the resolution of the image signal in accordance with the writing resolution of the exposure device 3, binarizes the image signal by halftoning, and outputs the binarized image signal to the exposure device 3.

### 1-5. Luminance-Density Conversion

The printer control unit 121 refers to the luminance-density conversion table held in the memory 212, and converts the luminance information (luminance signal) of the scanned image obtained by the reader 130 into density information (density signal). The luminance-density conversion table is a table for accepting (inputting) luminance values of any one of RGB channels in the scanned images and outputting the density values of YMCK.

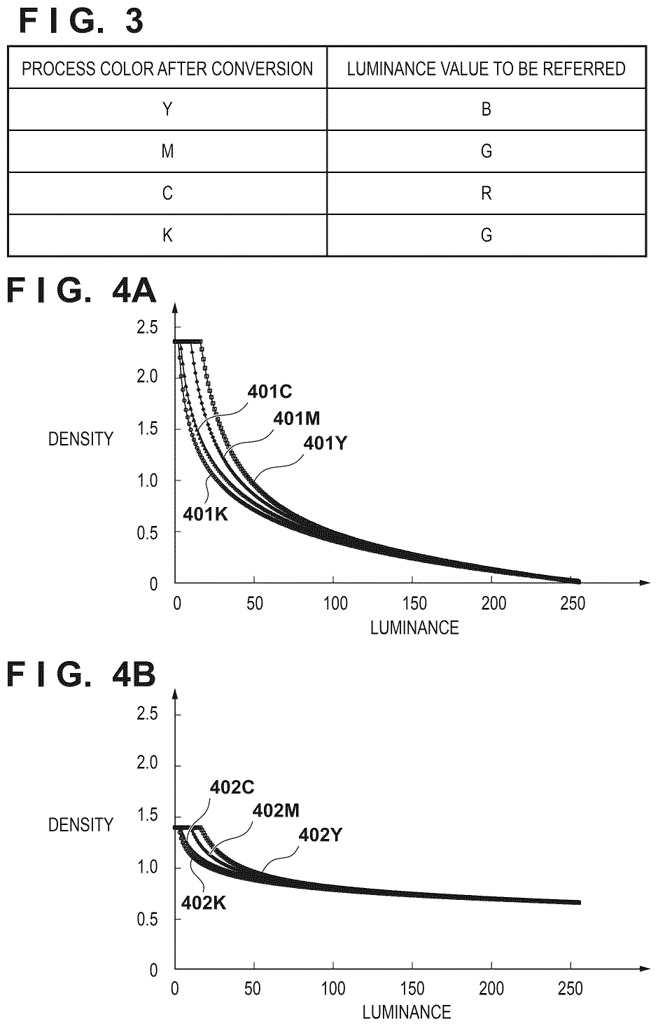

FIG. 3 shows the correspondence between YMCK and RGB. The density value of K is obtained by inputting the luminance value of the G channel of the scanned image into the luminance-density conversion table of K. The object for the luminance-density conversion is a scanned image obtained from an output material printed in a single color of YMCK. Here, the output material printed in a single color refers to a sheet P on which an image is formed by a color material of one of YMCK among the images formed on the sheet P.

The memory 212 stores a plurality of luminance-density conversion tables in advance. The CPU 211 selects a luminance-density conversion table corresponding to the type of the document 131 to be read from the plurality of luminance-density conversion tables. For example, when a test pattern for the tone correction is read, a luminance-density conversion table for the tone correction is selected. When the test pattern for the density unevenness correction is read, a luminance-density conversion table for the density unevenness correction is selected. In the luminance-density conversion table for the tone correction, a density of 0 or more and 2.3 or less corresponds to a luminance of 0 or more and 255 or less. In the luminance-density conversion table for the density unevenness correction, a density of 0.6 or more and 1.4 or less corresponds to a luminance of 0 or more and 255 or less.

The test pattern for the tone correction is further associated with an amount of light and a gain for the tone correction. That is, the luminance-density conversion table for the tone correction, the amount of light for the tone correction, and the gain form one parameter set. Similarly, the test pattern for the density unevenness correction is associated with the amount of light and the gain for the density unevenness correction. That is, the luminance-density conversion table for the density unevenness correction, the amount of light for the density unevenness correction, and the gain form one parameter set.

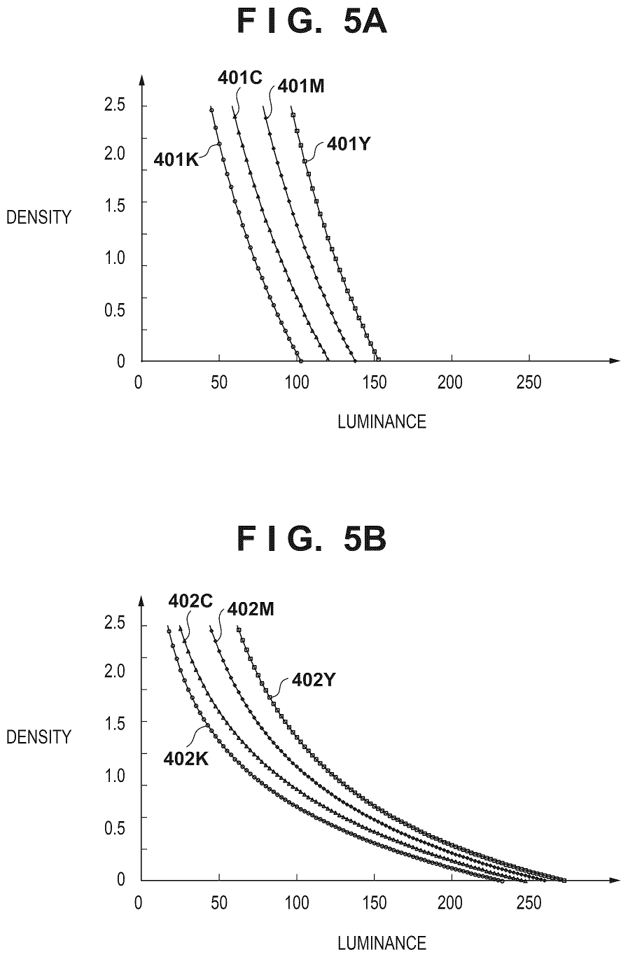

FIG. 4A shows a luminance-density conversion table 401Y, 401M, 401C, 401K for tone correction. FIG. 4B shows a luminance-density conversion table 402Y, 402M, 402C, 402K for correcting density unevenness. FIG. 5A is an enlarged view of FIG. 4A. FIG. 5B is an enlarged view of FIG. 4B.

A convertible density range of the luminance-density conversion table 401Y, 401M, 401C, 401K for the tone correction is wider than a convertible density range of the luminance-density conversion table 402Y, 402M, 402C, 402K for the density unevenness correction. That is, the convertible density range of the luminance-density conversion table 402Y, 402M, 402C, 402K for the density unevenness correction is narrower than the convertible density range of the luminance-density conversion table 401Y, 401M, 401C, 401K for the tone correction.

The density resolution of the luminance-density conversion table 401Y, 401M, 401C, 401K for the tone correction is lower than the density resolution of the luminance-density conversion table 402Y, 402M, 402C, 402K for the density unevenness correction. That is, the density resolution of the luminance-density conversion table 402Y, 402M, 402C, 402K for the density unevenness correction is higher than the density resolution of the luminance-density conversion table 401Y, 401M, 401C, 401K for the tone correction. Here, the smaller a change in density with respect to a change in luminance of one level, the higher a density resolution. The greater the change in density with respect to the change in luminance of one level, the lower the density resolution.

Here, the luminance-density conversion table 401 for the tone correction and the luminance-density conversion table 402 for the density unevenness correction are exemplified. However, a third luminance-density conversion table may be further added. For example, a luminance-density conversion table may be prepared for each type of sheet (e.g., basis weight, thickness). A luminance-density conversion table may be prepared for each shipping destination of the copying machine 100. In a case where a plurality of readers 130 are connected to the printer 120, a luminance-density conversion table may be provided for each reader 130. Here, the CPU 211 or the CPU 241 selects a corresponding luminance-density conversion table for each type, destination, or reader 130 of the sheet P.

### 1-6. CPU and Image Processing Unit

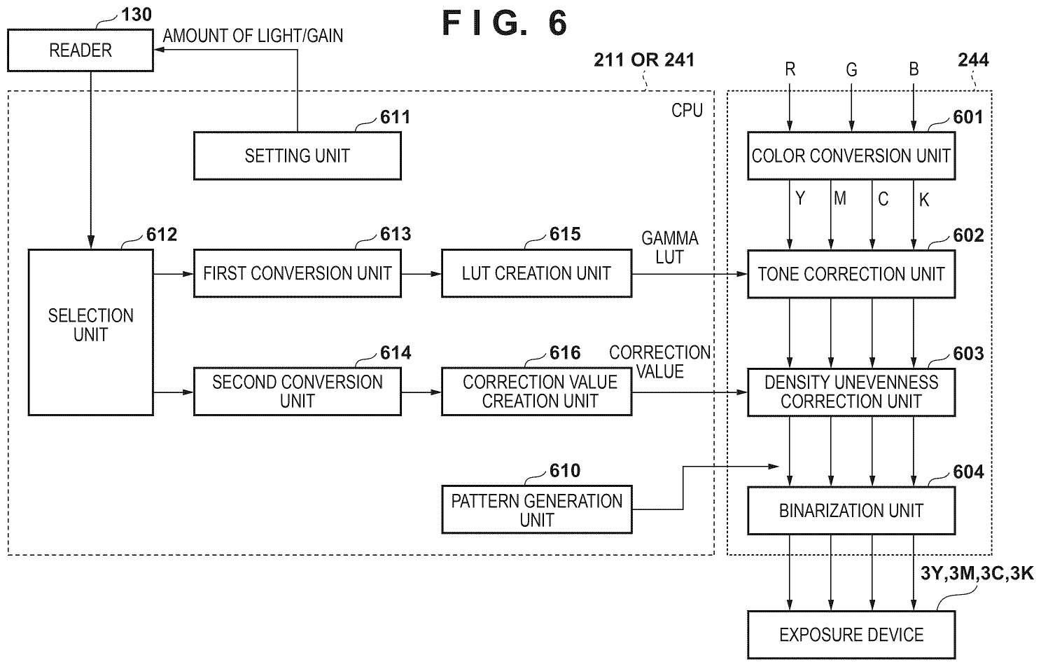

FIG. 6 shows functions realized by the CPU 211 and functions realized by the CPU 241 of the image processing apparatus 122. In the following, the described functions of the CPU 211 may be implemented by the CPU 241. That is, a part or all of the functions illustrated in FIG. 6 may be executed by the CPU 241 of the image processing apparatus 122.

The image processing unit 244 includes a color conversion unit 601, a tone correction unit 602, an unevenness correction unit 603, and a binarization unit 604. The color conversion unit 601 converts the scanned image obtained from the document 131 and the raster image data generated from the PDL data, from RGB format to YMCK format. The tone correction unit 602 converts the inputted YMCK image signal using a tone correction table (gamma LUT) created by an LUT creation unit 615. The term “LUT” is an abbreviation for lookup table. The unevenness correction unit 603 corrects the image signal outputted from the tone correction unit 602 using the correction value generated so as to reduce the density unevenness occurring in a main-scanning direction or the sub-scanning direction. The binarization unit 604 converts an 8-bit image signal outputted from the unevenness correction unit 603 into a 1-bit image signal by halftoning, and outputs the image signal to the exposure device 3.

### 1-6-1. Creating Gamma LUT

When the tone correction is instructed through the operation unit 140, the pattern forming unit 610 outputs an image signal corresponding to the test pattern for the tone correction to the binarization unit 604. As a result, a test pattern (test image) for the tone correction is formed on the sheet P. The sheet P on which the test image is formed may be referred to as a test chart.

The setting unit 611 sets the amount of light for the tone correction and the gain to the reader 130. The reader 130 reads the test chart and generates a scanned image.

The selection unit 612 selects the first conversion unit 613. This corresponds to selecting the luminance-density conversion table 401 for the tone correction. The selection unit 612 transfers the scanned image obtained from the reader 130 to the first conversion unit 613. The first conversion unit 613 converts the luminance information of the scanned image into the density information by using the luminance-density conversion table 401 for the tone correction. As illustrated in FIG. 3, the luminance-density conversion table 401Y converts the luminance information of the B channel into the density information of Y. The luminance-density conversion table 401M converts the luminance information of the G channel into the density information of M. The luminance-density conversion table 401C converts the luminance information of the R channel into the density information of C. The luminance-density conversion table 401K converts the luminance information of the G channel into the density information of K. The LUT creation unit 615 creates a gamma LUT for converting the image signal so that the tone characteristics of the image formed on the sheet P are ideal tone characteristics. The gamma LUT is created for each of YMCK. The LUT creation unit 615 sets the respective gamma LUTs of YMCK in the tone correction unit 602.

### 1-6-2. Creating Correction Values for the Density Unevenness Correction

When the density unevenness correction is instructed through the operation unit 140, the pattern forming unit 610 outputs an image signal corresponding to the test pattern for the density unevenness correction to the binarization unit 604. As a result, a test pattern (test image) for correcting the density unevenness is formed on the sheet P.

The setting unit 611 sets the amount of light for the density unevenness correction and the gain in the reader 130. The reader 130 reads the test chart and generates a scanned image. In the present disclosure, a configuration in which both the amount of light and the gain are adjusted is adopted, but at least a configuration in which the gain is adjusted may be adopted. In this configuration, the gain for the tone correction and the gain for the density unevenness correction are different, and the amount of light for the tone correction and the amount of light for the density unevenness correction are the same.

The selection unit 612 selects the second conversion unit 614. This corresponds to selecting the luminance-density conversion table 402 for the density unevenness correction. The selection unit 612 transfers the scanned image obtained from the reader 130 to the second conversion unit 614. The second conversion unit 614 converts the luminance information of the scanned image into the density information by using the luminance-density conversion table 402 for the density unevenness correction. As illustrated in FIG. 3, the luminance-density conversion table 402Y converts the luminance information of the B channel into the density information of Y. The luminance-density conversion table 402M converts the luminance information of the G channel into the density information of M. The luminance-density conversion table 402C converts the luminance information of the R channels into the density information of C. The luminance-density conversion table 402K converts the luminance information of the G channel into the density information of K. The correction value creation unit 616 generates a correction value such that unevenness in density of an image formed on the sheet P is reduced. The correction value is created for each position or block in the main-scanning direction. The unevenness correction unit 603 corrects the image signal using a correction value corresponding to each pixel in the main-scanning direction. In Embodiment 2 described later, correction values for reducing density unevenness in the sub-scanning direction are generated.

### 1-7. User Interface (UI)

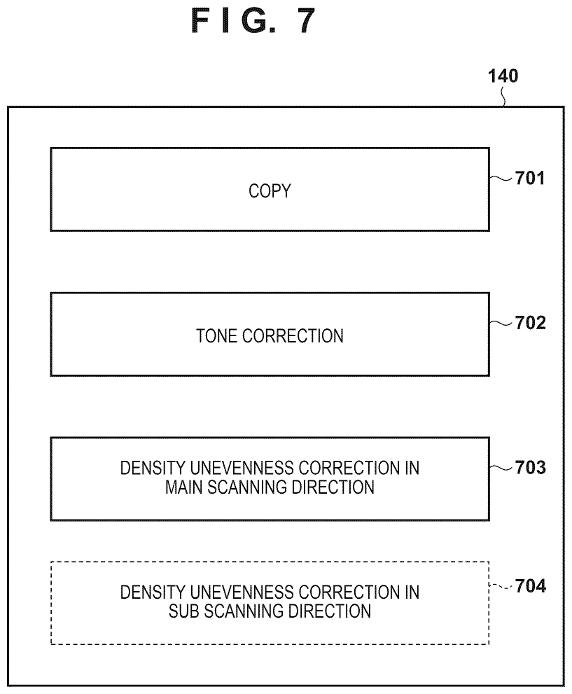

FIG. 7 shows a UI displayed on a display device of the operation unit 140. A button 701 is a button for instructing the copying machine 100 to execute copying of the document 131. A button 702 is a button for instructing the copying machine 100 to execute the tone correction. A button 703 is a button for instructing the copying machine 100 to perform correction of density unevenness in the main-scanning direction. A button 704 is a button for instructing the copying machine 100 to perform correction of density unevenness in the sub-scanning direction. The correction of the density unevenness in the sub-scanning direction will be described in detail in Embodiment 2.

### 1-8. Test Pattern

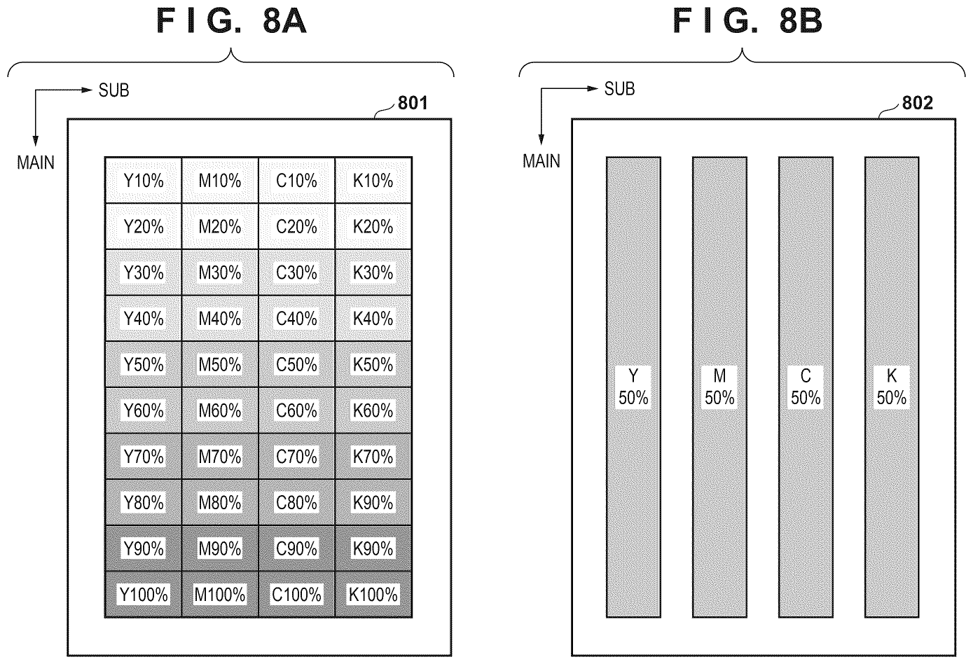

FIG. 8A shows a test pattern 801 for the tone correction. Test pattern 801 includes n-tone patch images that differ for each color of YMCK. Here, as an example, n is assumed to be 10.

FIG. 8B shows a test pattern 802 for correcting density unevenness. The test pattern 802 includes patch images of a constant tone extending in the main-scanning direction for the respective colors of YMCK.

### 1-9. Flowchart

### 1-9-1. Tone Correction

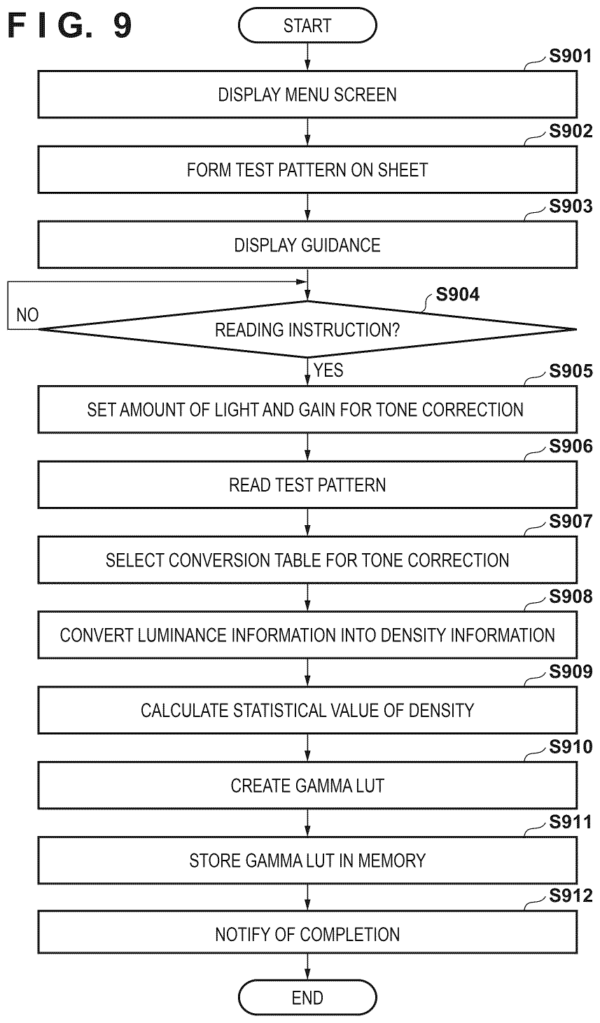

FIG. 9 shows a method for creating the gamma LUT by the CPU 211. As described above, the gamma LUT is a table for keeping the relationship between the output density and the input image signal (hereinafter referred to as a tone characteristic) for the respective colors of YMCK constant. The following steps may be performed by the CPU 241. In such cases, the CPU 211 is read as the CPU 241 in the following explanation.

In S901, the CPU 211 displays a menu screen on the display device of the operation unit 140. As illustrated in FIG. 7, the menu screen includes the button 701 for instructing execution of the tone correction. When the CPU 211 detects that the button 701 has been pressed by the user, it proceeds from S901 to S902.

In S902, the CPU 211 (pattern forming unit 610) controls the image forming unit 123 to form the test pattern 801 on the sheet P. Specifically, the pattern forming unit 610 supplies the image signal that is a source of the test pattern 801 to the binarization unit 604. The binarization unit 604 binarizes the input image signal and supplies it to the exposure device 3. As a result, the test pattern 801 is formed on the sheet P. The sheet P (test chart) on which the test pattern 801 is formed is discharged to the sheet tray 12.

In S903, the CPU 211 displays guidance on the display device of the operation unit 140. The guidance includes a message and an image indicating to the user that the test chart should be placed on the document table 132, the orientation of the test chart on the document table 132, and the like. In addition, the guidance may include a message or an image indicating that the user should press a button for instructing the start of reading of the test chart. This button may be a button indicating that the user has completed placing the test chart on the document table 132.

In S904, the CPU 211 determines whether a reading instruction is inputted through the operation unit 140. When the reading instruction is inputted, the CPU 211 proceeds from S904 to S905.

In S905, the CPU 211 (setting unit 611) sets the amount of light and the gain for the tone correction to the reader 130.

In S906, the CPU 211 controls the reader 130 to read the test pattern 801. The reader 130 generates and transfers a scanned image of the test pattern 801. The printer control unit 121 obtains a scanned image by the communication circuit 213, and stores the scanned image in the memory 212.

In S907, the CPU 211 (selection unit 612) selects the luminance-density conversion table 401 (first conversion unit 613) for the tone correction.

In S908, the CPU 211 (first conversion unit 613) converts the luminance information (luminance value) of the scanned image into the density information (density value) using the luminance-density conversion table 401 for tone correction.

In S909, the CPU 211 (LUT creation unit 615) calculates a statistical value of the density. As shown in FIG. 8A, the test pattern 801 includes N patch images having different tones. Therefore, the LUT creation unit 615 obtains density values at M positions for one patch image (one tone), and calculates a statistical value (e.g., an average value) from M density values. This process is performed for each of YMCK. N statistical values are obtained for each color.

In S910, the CPU 211 (LUT creation unit 615) generates the gamma LUTs. For example, the LUT creation unit 615 generates gamma LUTs from the N statistical values for the density, the input image signal used to generate the test pattern 801, and a target of the tone.

In S911, the CPU 211 (LUT creation unit 615) stores the gamma LUTs for the respective colors of YMCK in the memory 212. As a result, the tone correction unit 602 can refer to the gamma LUT.

In S912, the CPU 211 notifies the user of the completion of the tone correction (the process of creating the gamma LUTs). For example, the CPU 211 may display a message indicating that the tone correction is completed on the display device of the operation unit 140.

### 1-9-2. Density Unevenness Correction in the Main-Scanning Direction

The density unevenness correction in the main-scanning direction is a process of correcting an image signal using a correction value in order to maintain uniformity of a density in the main-scanning direction with respect to a constant input image signal. Specifically, the image signal is corrected so that the density profile in the main-scanning direction becomes uniform. In the density unevenness correction, there is requirement that a density be detected in a predetermined range with a high resolution. Therefore, a set of the amount of light for the density unevenness correction, the gain, and the luminance-density conversion table 402 is used. In the present embodiment, YMCK color-patch images are divided into K blocks, and the density values are calculated for each block. K is 30, for example.

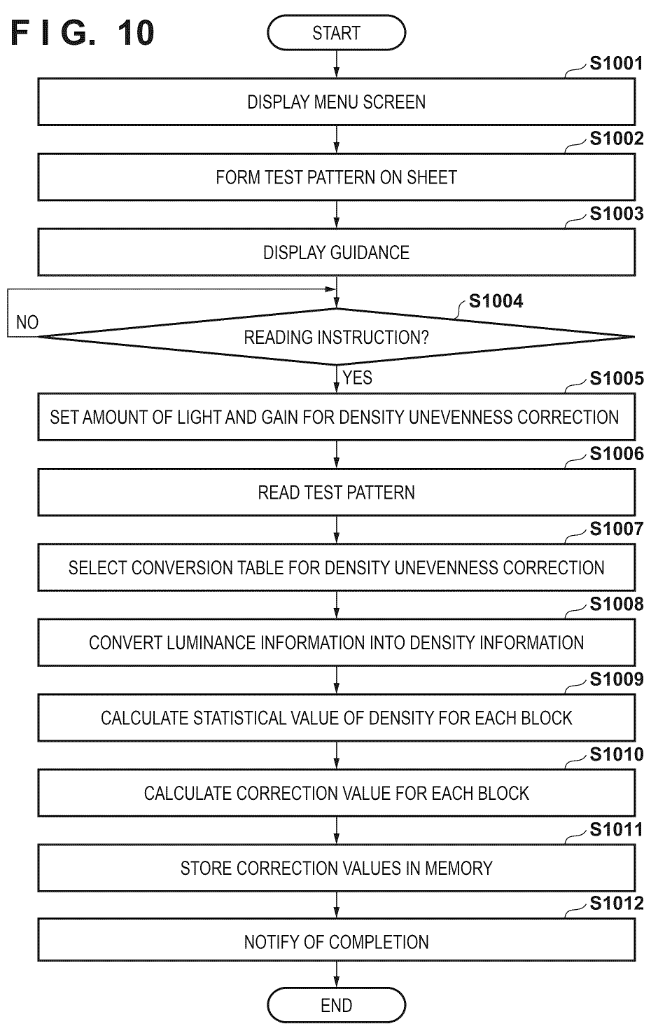

FIG. 10 shows a method for creating the correction value performed by the CPU 211. The following steps may be performed by the CPU 241. In such cases, the CPU 211 is read as the CPU 241 in the following explanation.

In S1001, the CPU 211 displays a menu screen on the display device of the operation unit 140. As illustrated in FIG. 7, the menu screen includes the button 703 for instructing execution of density unevenness correction. When the CPU 211 detects that the button 703 has been pressed by the user, it proceeds from S1001 to S1002.

In S1002, the CPU 211 (pattern forming unit 610) controls the image forming unit 123 to form the test pattern 802 on the sheet P. Specifically, the pattern forming unit 610 supplies the image signal that is a source of the test pattern 802 to the binarization unit 604. The binarization unit 604 binarizes the input image signal and supplies it to the exposure device 3. As a result, the test pattern 802 is formed on the sheet P. The sheet P (test chart) on which the test pattern 802 is formed is discharged to the sheet tray 12.

In S1003, the CPU 211 displays guidance on the display device of the operation unit 140. The guidance includes a message and an image indicating that the test chart should be placed on the document table 132, the orientation of the test chart on the document table 132, and the like to the user. In addition, the guidance may include a message or an image indicating that the user should press a button for instructing the start of reading of the test chart. This button may be a button indicating that the user has completed placing the test chart on the document table 132.

In S1004, the CPU 211 determines whether a reading instruction is inputted through the operation unit 140. When the reading instruction is inputted, the CPU 211 proceeds from S1004 to S1005.

In S1005, the CPU 211 (setting unit 611) sets the amount of light for correcting the density unevenness and the gain in the reader 130.

In S1006, the CPU 211 causes the reader 130 to read the test pattern 801. The reader 130 generates a scanned image for the test pattern 802, and transfers the scanned image to the printer control unit 121 using the communication circuit 233. The printer control unit 121 obtains a scanned image by the communication circuit 213, and stores the scanned image in the memory 212.

In S1007, the CPU 211 (selection unit 612) selects the luminance-density conversion table 402 (second conversion unit 614) for correcting the density unevenness.

In S1008, the CPU 211 (second conversion unit 614) converts the luminance information (luminance value) of the scanned images into the density information (density value) in the density correction luminance-density conversion table 402.

In S1009, the CPU 211 (correction value creation unit 616) calculates a statistical value of the density. As shown in FIG. 8B, the test pattern 802 includes patch images for each YMCK extending in the main-scanning direction. The correction value creation unit 616 divides each patch image into K small regions (blocks). The correction value creation unit 616 obtains density values at J positions for one block (main scanning position), and calculates a statistical value (e.g., average value) from the J density values. This process is performed for each of YMCK. K statistical values are obtained for each color.

In S1010, the CPU 211 (correction value creation unit 616) calculates a correction value of the image signal for each block. For example, the correction value creation unit 616 calculates a correction value of the image signal for each block from the K statistical values and the tone target for the density. The correction values are computed for each color of YMCK.

In S1011, the CPU 211 (correction value creation unit 616) stores correction values for YMCK colors in the memory 212. As a result, the unevenness correction unit 603 can refer to the correction value. The correction value may be stored in the memory 212 for each pixel arranged in the main-scanning direction.

In S1012, the CPU 211 notifies the user of completion of the density unevenness correction (creation of the correction values). For example, the CPU 211 may display a message indicating that the density unevenness correction has been completed on the display device of the operation unit 140.

### 1-10. Other

According to Embodiment 1, the luminance-density conversion table 401 for the tone correction and the luminance-density conversion table 402 for the density unevenness correction are prepared. In the luminance-density conversion table 401 for the tone correction, the width of the density range is given priority over the density resolution. In the luminance-density conversion table 402 for the density unevenness correction, the density resolution is given priority over the width of the density range. The CPU 211 can achieve both a wide density range and a high-density resolution by selectively using two luminance-density conversion tables.

Embodiment 1 may be modified as long as the two luminance-density conversion tables are selectively used. For example, the bit depth of the scanned image, the bit depth of the luminance-density conversion table, the test pattern 801 for the tone correction, the test pattern 802 for the density unevenness correction, the tone target, the number of blocks in the main-scanning direction, and the like may be changed. In Embodiment 1, a correction value for correcting the density unevenness in the main-scanning direction is calculated using the test pattern 802 having a single tone. However, the correction values may be calculated for each of the plurality of tones. In this case, the test pattern 802 may have a plurality of tone patch images for each color. In addition, the luminance-density conversion table 402 corresponding to each tone may be used.

A start condition of the tone correction and a start condition of the density unevenness correction do not need to be instructed by the user. For example, the start condition may be that a component involved in image formation (e.g., process cartridge, exposure device 3) has been replaced. The start condition may be that the total number of printed sheets exceeds the threshold number of printed sheets. The start condition may be that the sensor has detected a predetermined state or the like.

### 2. Embodiment 2

In Embodiment 2, the tone correction performed by using the reading apparatus connected in series to the image forming apparatus and the density unevenness correction in the sub-scanning direction are described.

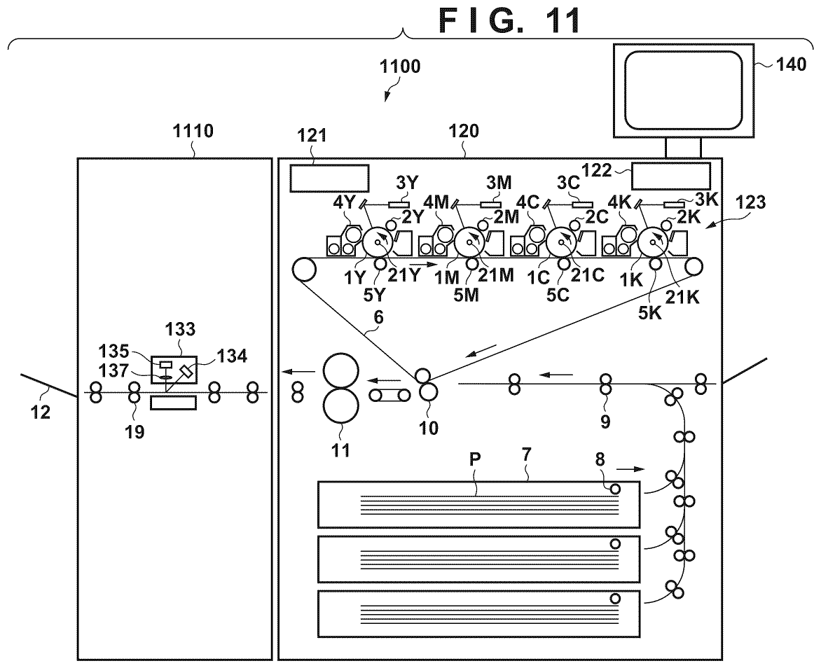

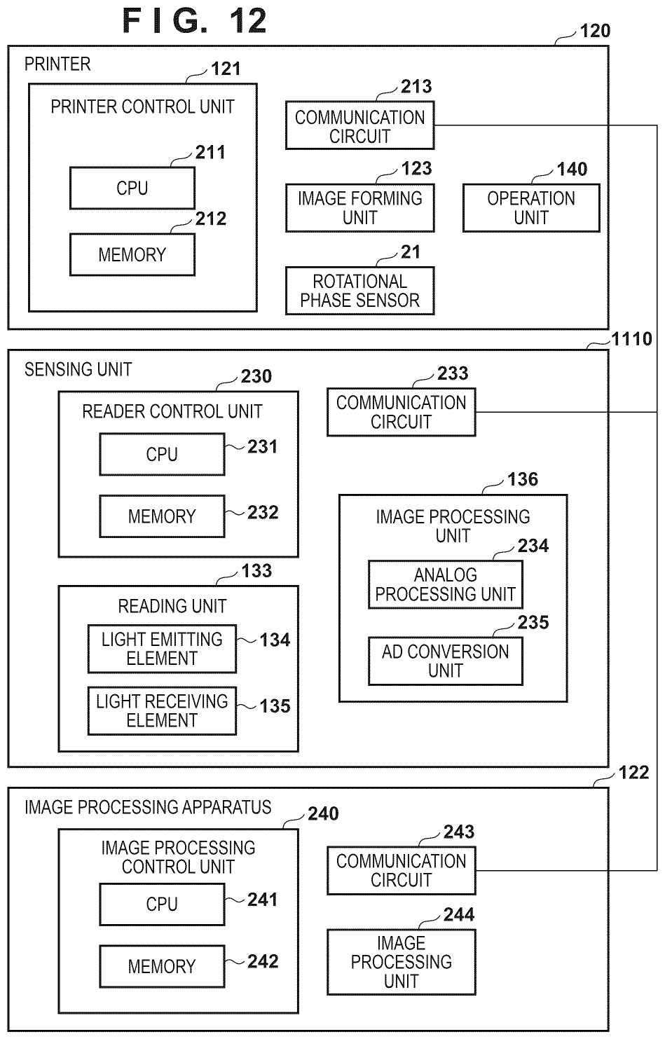

FIG. 11 shows an image forming system 1100. FIG. 12 shows a control system and an image processing system. The image forming system 1100 includes an image processing apparatus 122, a printer 120, and a reading apparatus (hereinafter referred to as a sensing unit) 1110. Most of Embodiment 2 is common to Embodiment 1. Therefore, the description of the common part is omitted. In the following, specific contents of Embodiment 2 will be mainly described.

As shown in FIG. 11, the sensing unit 1110 includes a reading unit 133. The reading unit 133 reads an image from the sheet P discharged from the printer 120 to the sensing unit 1110 and conveyed through the conveyance path by the conveyance roller 19. As described above, the reading unit 133 includes the light emitting element 134, the imaging optical system 137, and the light receiving element 135. The sheet P is discharged to the sheet tray 12 provided in the sensing unit 1110. The reader 130 of Embodiment 1 causes the reading unit 133 to read the sheet P while moving the reading unit 133 in the sub-scanning direction. The sensing unit 1110 causes the reading unit 133 to read the sheet P while the reading unit 133 is fixed. In any case, the reading unit 133 and the sheet P (document 131) relatively move in the sub-scanning direction in common.

In the printer 120, the photosensitive drums 1Y, 1M, 1C, 1K have a rotational phase sensor 21Y, 21M, 21C, 21K, respectively. The rotational phase sensor 21 detects the rotational phase of the photosensitive drum 1 and transmits the detection result to the printer control unit 121. Upon receiving the print job, the printer control unit 121 rotates the photosensitive drum 1 to adjust the rotational phase so that the rotational phase of the photosensitive drum 1 at the leading edge of the image becomes 0.

The rotational phase sensor 21 includes, for example, a photo interrupter attached to the printer 120 and a light shielding plate attached to a cylinder of the photosensitive drum 1. The photo interrupter includes a light emitting element and a light receiving element. The light shielding plate passes between the light emitting element and the light receiving element, and thereby blocks light from the light emitting element toward the light receiving element. Therefore, the rotational phase sensor 21 detects the rotational phase based on whether the photo interrupter is in a light shielding state or a light transmitting state. When the photo interrupter is in the light shielding state, the rotational phase sensor 21 outputs 1. When the photo interrupter is in the light transmitting state, the rotational phase sensor 21 outputs 0.

The rotational phase of the photosensitive drum 1 takes a value from 0 to 2 pi. The printer control unit 121 determines that the rotational phase of the photosensitive drum 1 is 0 when the output of the rotational phase sensor 21 rises from 0 to 1. Each time the photosensitive drum 1 rotates 360 degrees, the rotational phase proceeds by 2 pi.

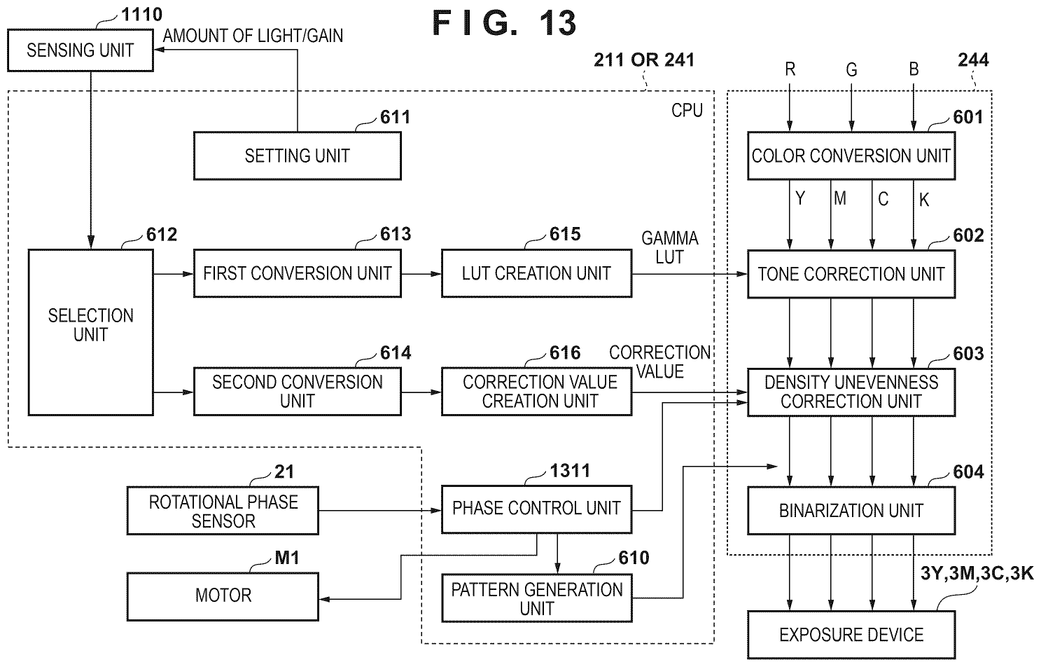

FIG. 13 shows the functions of the CPU 211 and the functions of the image processing apparatus 122. FIG. 14 shows a test pattern 1400 for correcting density unevenness in the sub-scanning direction. The phase control unit 1311 determines the rotational phase of the photosensitive drum 1 based on the detection result of the rotational phase sensor 21. In order to make the leading edge of the images on the photosensitive drum 1 coincide with the 0 of the rotational phase, the phase control unit 1311 monitors the rotational phase detected by the rotational phase sensor 21. The phase control unit 1311 controls the motor M1 so that the rotational phase detected by the rotational phase sensor 21 becomes 0. Furthermore, at a timing when the rotational phase becomes 0, the phase control unit 1311 instructs the pattern forming unit 610 to output the image signal that is the basis of the test pattern 1400. As a result, the leading edge of the test pattern 1400 in the sub-scanning direction matches 0 (which may be referred to as a reference phase or a home position) of the rotational phase. As shown in FIG. 14, the test pattern 1400 includes patch images of constant tones (e.g., 50%) extending parallel to the sub-scanning direction. The patch images are formed for each color of YMCK.

The setting unit 611 sets, in the reader control unit 230 of the sensing unit 1110, the amount of light and the gain for correcting the density unevenness in the sub-scanning direction. The amount of light and gain for the density unevenness correction in the sub-scanning direction are stored in the memory 212 in association with the luminance-density conversion table 402 for the density unevenness correction in the sub-scanning direction. The luminance-density conversion table 402 for correcting the density unevenness in the main-scanning direction may be different from the luminance-density conversion table 402 for correcting the density unevenness in the sub-scanning direction. As described in Embodiment 1, the reader control unit 230 turns on the light emitting element 134 with the set amount of light. Further, the reader control unit 230 sets the gain in the analog processing unit 234 of the image processing unit 136. The image processing unit 136 generates a scanned image of the test pattern 1400 and transmits the scanned image to the printer control unit 121.

The CPU 211 (selection unit 612) selects the luminance-density conversion table 402 (second conversion unit 614) for correcting the density unevenness in the sub-scanning direction. The second conversion unit 614 converts the luminance information of the scanned image of the test pattern 1400 into the density information using the luminance-density conversion table 402 for correcting the density unevenness in the sub-scanning direction. The correction value creation unit 616 generates a correction value for each rotational phase based on the density information, and stores the correction value in the memory 212. The unevenness correction unit 603 reads out the correction value corresponding to the rotational phase from the memory 212 and corrects the image signal.

### 2-1. Tone Correction Flowchart

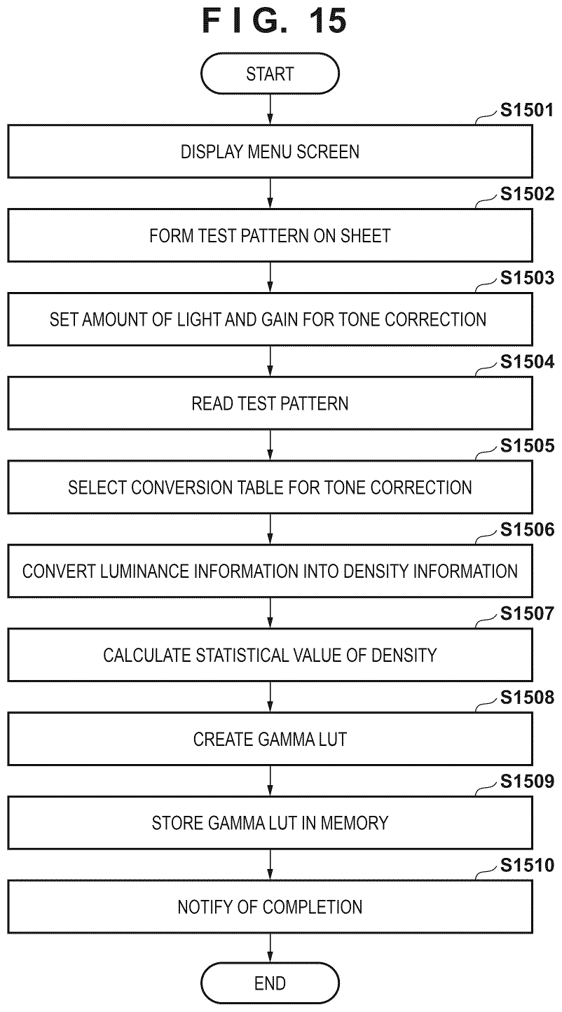

FIG. 15 shows a method for creating a gamma LUT executed by the CPU 211. The following steps may be performed by the CPU 241. In such cases, the CPU 211 is read as the CPU 241 in the following explanation.

In S1501, the CPU 211 displays a menu screen on the display device of the operation unit 140. As illustrated in FIG. 7, the menu screen includes the button 701 for instructing execution of tone correction. When the CPU 211 detects that the button 701 has been pressed by the user, it proceeds from S1501 to S1502.

In S1502, the CPU 211 (pattern forming unit 610) controls the image forming unit 123 to form a test pattern 801 on the sheet P. Specifically, the pattern forming unit 610 supplies the image signal that is the source of the test pattern 801 to the binarization unit 604. The binarization unit 604 binarizes the input image signal and supplies it to the exposure device 3. As a result, the test pattern 801 is formed on the sheet P. The sheet P (test chart) on which the test pattern 801 is formed is discharged to the sheet tray 12.

In S1503, the CPU 211 (setting unit 611) sets the amount of light for tone correction and the gain to the reader 130.

In S1504, the CPU 211 causes the sensing unit 1110 to read the test pattern 801. The sensing unit 1110 generates a scanned image for the test pattern 801, and transfers the scanned image to the printer control unit 121 using the communication circuit 233. The printer control unit 121 obtains a scanned image by the communication circuit 213, and stores the scanned image in the memory 212.

In S1505, the CPU 211 (selection unit 612) selects the luminance-density conversion table 401 (first conversion unit 613) for the tone correction.

In S1506, the CPU 211 (first conversion unit 613) converts the luminance information (luminance value) of the scanned image into the density information (density value) in the luminance-density conversion table 401 for the tone correction.

In S1507, the CPU 211 (LUT creation unit 615) calculates a statistical value of a density. As shown in FIG. 8A, the test pattern 801 includes N patch images having different tones. Therefore, the LUT creation unit 615 obtains density values at M positions for one patch image (one tone), and calculates a statistical value (e.g., an average value) from the M density values. This process is performed for each of YMCK. N statistical values are obtained for each color.

In S1508, the CPU 211 (LUT creation unit 615 generates gamma LUTs from the N statistical values for the density, the input image signal used to create the test pattern 801, and the tone target.

In S1509, the CPU 211 (LUT creation unit 615) stores the gamma LUTs for YMCK colors in the memory 212. As a result, the tone correction unit 602 can refer to the gamma LUTs.

In S1510, the CPU 211 notifies the user of the completion of the tone correction values (the process of creating gamma LUTs). For example, the CPU 211 may display a message indicating that the tone correction is completed on the display device of the operation unit 140.

### 2-2. Density Unevenness Correction in the Sub-Scanning Direction

Periodic density unevenness may occur in synchronization with the rotational phase of the photosensitive drum 1. Therefore, the correction value of the image signal for each rotational phase of the photosensitive drum 1 is created. As a result, the density profile in the sub-scanning direction becomes uniform. Even in the density unevenness correction in the sub-scanning direction, the density in a predetermined range needs to be detected with high resolution. Therefore, the amount of light for the density unevenness correction, the gain, and the luminance-density conversion table are used in the set. In Embodiment 2, patch images of YMCK colors in the test pattern 1400 are divided into L blocks (sub-scanning positions or rotational phases). Lis, for example, 60.

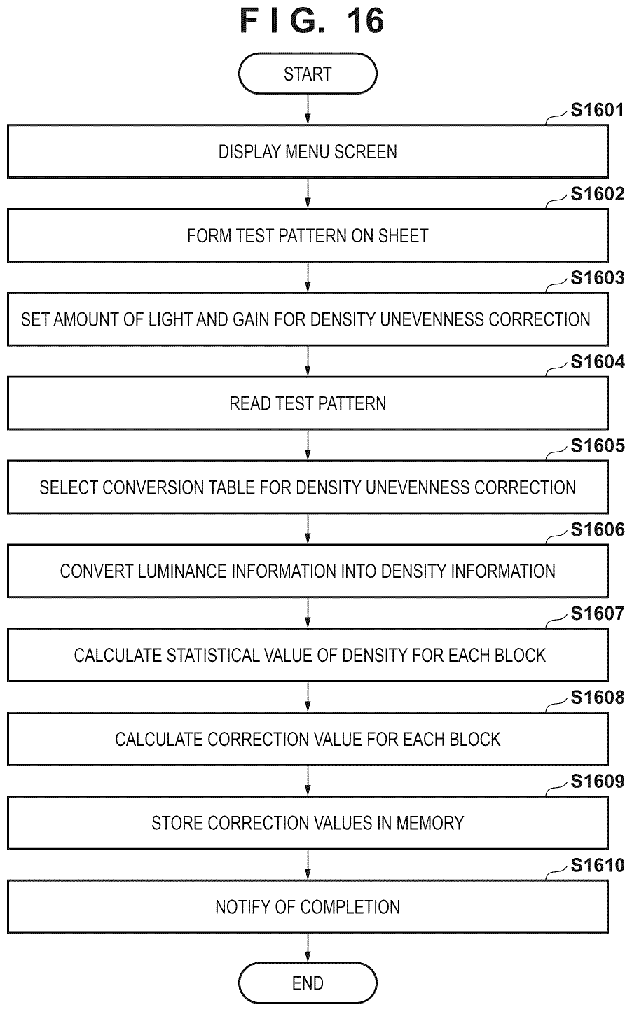

FIG. 16 shows a method for creating correction values executed by the CPU 211. The following steps may be performed by the CPU 241. In such cases, the CPU 211 is read as the CPU 241 in the following explanation.

In S1601, the CPU 211 displays a menu screen on the display device of the operation unit 140. As illustrated in FIG. 7, the menu screen includes the button 703 for instructing execution of the density unevenness correction. When the CPU 211 detects that the button 703 has been pressed by the user, it proceeds from S1601 to S1602.

In S1602, the CPU 211 (pattern forming unit 610) controls the image forming unit 123 to form the test pattern 1400 on the sheet P. Specifically, the pattern forming unit 610 supplies the image signal that is the source of the test pattern 1400 to the binarization unit 604. The binarization unit 604 binarizes the input image signal and supplies it to the exposure device 3. As a result, the test pattern 1400 is formed on the sheet P. The sheet P (test chart) on which the test pattern 1400 is formed is discharged to the sensing unit 1110.

In S1603, the CPU 211 (setting unit 611) sets the amount of light and the gain for correcting the density unevenness in the sub-scanning direction in the sensing unit 1110. In S1604, the CPU 211 causes the sensing unit 1110 to read the test pattern 1400. The sensing unit 1110 generates a scanned image for the test pattern 1400, and transfers the scanned image to the printer control unit 121 using the communication circuit 233. The printer control unit 121 obtains a scanned image by the communication circuit 213, and stores the scanned image in the memory 212.

In S1605, the CPU 211 (selection unit 612) selects the luminance-density conversion table 402 (second conversion unit 614) for correcting the density unevenness in the sub-scanning direction. In S1606, the CPU 211 (second conversion unit 614) converts the luminance information (luminance value) of the scanned images into the density information (density value) using the luminance-density conversion table 402 for the density correction.

In S1607, the CPU 211 (correction value creation unit 616) calculates a statistical value of the density. As shown in FIG. 14, the test pattern 1400 includes patch images for each YMCK extending parallel to the sub-scanning direction. The correction value creation unit 616 divides each patch image into L small regions (blocks). The correction value creation unit 616 obtains density values at J positions for one block (main scanning position), and calculates statistical values (e.g., average values) from the J density values. This process is performed for each of YMCK. L statistical values are obtained for each color.

In S1608, the CPU 211 (correction value creation unit 616) calculates correction values of the image signal for each block from the L statistical values and the tone targets for the density. The correction values are computed for each color of YMCK.

In S1609, the CPU 211 (correction value creation unit 616) stores the correction value for each color of YMCK in the memory 212 in association with the block number, the rotational phase, or the sub-scanning position. Thus, the unevenness correction unit 603 can refer to the correction value based on the block number, the rotational phase, or the sub-scanning position. The correction value may be stored in the memory 212 for each pixel arranged in the sub-scanning direction.

In S1610, the CPU 211 notifies the user of completion of the density unevenness correction (creation of correction values). For example, the CPU 211 may display a message indicating that the density unevenness correction has been completed on the display device of the operation unit 140.

### 2-3. Other

The effect described in Embodiment 1 is also expected in Embodiment 2. In other words, the CPU 211 can achieve both a wide density range and a high-density resolution by selectively using two luminance-density conversion tables.

The CPU 211 may perform a frequency analysis of the density profile detected from the test pattern 1400 by the sensing unit 1110. The CPU 211 may generate a correction value that corrects only density unevenness of a particular frequency determined by the frequency analysis. In addition to the tone correction and the density unevenness correction in the sub-scanning direction, the CPU 211 may perform the density unevenness correction in the main-scanning direction.

### 3. Another Embodiment

The printer 120 and the image forming unit 123 are examples of an image forming unit that forms an image on the sheet P using a color material (for example, toner). The first conversion unit 613, the second conversion unit 614, and the luminance-density conversion tables 401 and 402 are examples of the first conversion condition and the second conversion condition. These units convert the luminance information into the density information, wherein the luminance information is obtained from a reading apparatus (for example, the reader 130 or the sensing unit 1110) that irradiates the sheet P on which an image is formed by the printer 120 with light, receives the reflected light from the sheet or the image and generates luminance information. Note that the light emitting element 134 acts as an irradiation unit that irradiates the test image formed by the image forming unit 123 with light. The light receiving element 135 acts as an output unit that receives the reflected light from the test image and outputs a signal based on the received result of the reflected light from the test image. The CPUs 211 and 241 and the like act as a control unit. In some cases, the first calibration for correcting the tone characteristic of the image to be formed by the image forming unit 123 is performed. In this case, the CPUs 211 and 241 may convert the first signal based on the light reception result of the reflected light from the first test image formed by the image forming unit 123 based on the first conversion condition, and correct the tone characteristic based on the converted first signal. In some cases, a second calibration for correcting density unevenness in a predetermined direction of an image to be formed by the image forming unit 123 is performed. In this case, the CPUs 211 and 241 convert the second signal based on the light reception result of the reflected light from the second test image formed by the image forming unit 123 based on the second conversion condition, and correct the density unevenness based on the converted second signal. As illustrated in FIGS. 4A and 4B, the scope of the density information that can be converted from the luminance information in the first conversion condition is wider than the range of the density information that can be converted from the luminance information in the second conversion condition. As illustrated in FIGS. 5A and 5B, the resolution of the density information that can be converted from the luminance information in the second conversion condition is higher than the resolution of the density information that can be converted from the luminance information in the first conversion condition. As described above, a wide density range and a high density resolution can be achieved by a plurality of conversion conditions.

The luminance-density conversion table 401 is an example of a first conversion table that converts luminance into density. The luminance-density conversion table 402 is an example of a second conversion table that converts luminance into density. As illustrated in FIGS. 4A and 4B, the difference between the maximum density and the minimum density in the second conversion table is smaller than the difference between the maximum density and the minimum density in the first conversion table.

The LUT creation unit 615 is an example of a first creation unit that creates a first image forming condition (e.g., gamma LUT) to be applied to the image forming unit on the basis of the first reading result obtained by the reading apparatus for the first test image (e.g., the test pattern 801) formed on the sheet P. The correction value creation unit 616 is an example of a second creation unit that creates a second image forming condition (e.g., correction value) to be applied to the image forming unit based on the second reading result obtained by the reading apparatus for the second test image (e.g., test patterns 802 and 1400) formed on the sheet P. The LUT creation unit 615 may generate the first image forming condition based on the density information by converting the luminance information of the first test image, which is the first reading result, into the density information by using the first conversion condition (e.g., the first conversion unit 613). The correction value creation unit 616 may generate the second image forming condition based on the density information by converting the luminance information of the second test image, which is the second reading result, into the density information by using the second conversion condition (e.g., the second conversion unit 614).

The first image forming condition may include a first image processing condition (e.g., gamma LUT) for correcting the tone characteristic of the image. The second image forming condition may include a second image processing condition (e.g., a correction value of the density) for reducing the density unevenness of the image.

The first image processing condition may include a tone correction table (e.g., gamma LUT) that receives an image signal as an input and outputs an image signal whose tone characteristics have been corrected. The second image processing condition may include a correction value of a density for each position or block where an image is formed on the sheet P.

As described in Embodiment 2, the correction value of the density may include a correction value for reducing the density unevenness in the first direction (for example, the sub-scanning direction) parallel to the conveyance direction of the sheet P. As described in Embodiment 1, the correction value of the density may include a correction value for reducing the density unevenness in the second direction (for example, the main-scanning direction) orthogonal to the conveyance direction P of the sheet.

The tone correction unit 602 acts as a tone correction unit that corrects the tone characteristics of the image signal that is the source of the image by using a tone correction table (for example, gamma LUT). The unevenness correction unit 603 acts as a density correction unit that corrects an image signal that is the original of an image by using the correction value of the density.

The setting unit 611 acts as a setting unit that sets the amount of light of the light emitting element 134 provided in the reader 130 and the gain of the light receiving element 135 provided in the reader 130. As described in connection with S905 and S1503, the setting unit 611 sets the first amount of light and the first gain to the reader 130 when reading the first test image. As described in connection with S1005 and S1603, the setting unit 611 may be configured to set the second amount of light and the second gain to the reader 130 when reading the second test image.

The selection unit 612 acts as a selection unit that selects a first conversion condition or a second conversion condition. The selection unit 612 selects the first conversion condition when creating the first image forming condition to be applied to the image forming unit (e.g., the image forming unit 123 and the image processing unit 244). The selection unit 612 selects the second conversion condition when creating the second image forming condition to be applied to the image forming unit (e.g., the image forming unit 123 and the image processing unit 244). As described above, the plurality of luminance-density conversion tables are selectively used depending on the application.

The selection unit 612 may select the first conversion condition when the first adjustment mode (for example, tone correction) is designated among the plurality of adjustment modes for adjusting the density of the image. The selection unit 612 may select the second conversion condition when the second adjustment mode (for example, density unevenness correction) is designated among the plurality of adjustment modes for adjusting the density of the image.

The reading apparatus may include an in-line type image sensor (for example, the sensing unit 1110 and the light receiving element 135) that is provided on the downstream side of the image forming unit in the sheet conveyance direction and reads an image from the sheet to be conveyed.

The reading apparatus may include an off-line type image sensor (e.g., reader 130 and light receiving element 135) that reads an image from the sheet P discharged from the printer 120 and placed by the user.

The printer control unit 121, the CPU 211, the reader control unit 230, the CPU 231, the image processing control unit 240, the CPU 241, and the like are exemplary controllers. The controller may cause the image forming unit 123 to form a first calibration test image, cause the analog processing unit 234 to amplify the first signal based on the light reception result of the reflected light from the first calibration test image output by the reading unit 133, determine the first density information based on the first determination condition from the amplified first signal, and adjust the tone characteristics of the image to be formed by the image forming unit 123 based on the first density information. The controller may cause the image forming unit 123 to form a second calibration test image, cause the analog processing unit 234 to amplify the second signal based on the light reception result of the reflected light from the second calibration test image output by the reading unit 133, determine the second density information based on the second determination condition from the amplified second signal, and adjust the density unevenness of the image to be formed by the image forming unit 123 based on the second density information. The gain of the second signal is higher than the gain of the first signal.

The reading unit 133 may comprise the light emitting element 134 for illuminating the test image. The amount of light that the light emitting element 134 illuminates the test image for the first calibration may be different from the amount of light that the light emitting element 134 illuminates the test image for the second calibration.

The density range that can be outputted as the first density information may be wider than the density range that can be outputted as the second density information.

The memory 212 stores various luminance-density conversion tables 401Y, 401M, 401C, 401K, 402Y, 402M, 402C, 402K. The first determination condition may be a density conversion table (e.g., a luminance-density conversion table 401Y, 401M, 401C, 401K) used to convert a predetermined number of bits of the digital signal into the first density information in the first density range. The second determination condition may be a density conversion table (e.g., a luminance-density conversion table 402Y, 402M, 402C, 402K) used to convert a predetermined number of bits of a digital signal into second density information in a second density range narrower than the first density range.

As shown in FIG. 8A, the test image for the first calibration (e.g., the test pattern 801) may include a plurality of images having different tones. As shown in FIG. 8B, the test image for the second calibration (e.g., the test patterns 802 and 1400) may be an image having a single tone.

The conveyance roller 9 conveys the sheet P to the conveyance path. The image forming unit 123 forms an image on the sheet P conveyed by the conveyance roller 9. Here, the second calibration may be a calibration for adjusting density unevenness in a direction orthogonal to a conveyance direction in which the conveyance roller 9 conveys the sheet P. The second calibration may be a calibration for adjusting density unevenness in the conveyance direction in which the conveyance roller 9 conveys the sheet P.

The resolution of the signal value as the second density information may be higher than the resolution of the signal value as the first density information.

The image forming unit 123 may include an image processing unit 244 that converts an input image signal based on a tone correction condition. The image forming unit 123 forms an image based on the converted image signal. In the first calibration, the controller (e.g., the CPUs 211 and 241) may create the tone correction condition based on the first density information.

The image forming unit 123 may include an image processing unit 244 that corrects an input image signal based on a correction value. The image forming unit 123 may form an image based on the corrected image signal. The controller (e.g., the CPUs 211 and 241) may create a correction value based on the second density information in the second calibration.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-042783, filed Mar. 18, 2024 and Japanese Patent Application No. 2025-009977, filed Jan. 23, 2025 which are hereby incorporated by reference herein in their entirety.

What is claimed is:

1. An image forming apparatus comprising:
an image forming unit configured to form an image;
a sensor configured to receive reflected light from a test image formed by the image forming unit and output a signal based on a result of receiving the reflected light from the test image;
an amplifier configured to amplify the signal outputted from the sensor based on a gain; and
a controller configured to:
control the image forming unit to form a test image for a first density calibration, control the amplifier to amplify a first signal outputted by the sensor, the first signal based on a result of receiving a reflected light from the test image for the first density calibration, and perform the first density calibration based on the amplified first signal by the amplifier; and
control the image forming unit to form a test image for a second density calibration, control the amplifier to amplify a second signal outputted by the sensor, the second signal based on a result of receiving a reflected light from the test image for the second density calibration, and perform the second density calibration based on the amplified second signal by the amplifier,
wherein a gain of the second signal is higher than a gain of the first signal.

2. The image forming apparatus according to claim 1, wherein
the sensor further comprises a light emitting element configured to illuminate the test image, and
an amount of the light that the light emitting element emits for illuminating the test image for the first density calibration is different from an amount of light that the light emitting element emits for illuminating the test image for the second density calibration.

3. The image forming apparatus according to claim 1, wherein
the first density calibration is an adjustment of a tone characteristic of an image to be formed by the image forming unit, and
the second density calibration is an adjustment of density unevenness of an image to be formed by the image forming unit.

4. The image forming apparatus according to claim 1, wherein
the controller is further configured to determine first density information from the amplified first signal, and perform the first density calibration from the first density information,
the controller is further configured to determine second density information from the amplified second signal, and perform the second density calibration from the second density information, and
a density range that can be outputted as the first density information is wider than a density range that can be outputted as the second density information.

5. The image forming apparatus according to claim 4, wherein
the controller is further configured to determine first density information from the amplified first signal based on a first determination condition,
the controller is further configured to determine second density information from the amplified first signal based on a second determination condition,
the first determination condition is a density conversion table used to convert a digital signal of a predetermined number of bits to the first density information of a first density range, and
the second determination condition is a density conversion table used to convert a digital signal of the predetermined number of bits into the second density information of a second density range narrower than the first density range.

6. The image forming apparatus according to claim 1, wherein
the test image for the first density calibration has an image having a plurality of different tones, and
the test image for the second density calibration is an image having a single tone.

7. The image forming apparatus according to claim 1, further comprising:
a conveyance roller configured to convey a sheet to the conveyance path,
wherein the image forming unit is further configured to form the image on the sheet conveyed by the conveyance roller, and
the second density calibration is a calibration for adjusting density unevenness in a direction orthogonal to a conveyance direction in which the conveyance roller conveys the sheet.

8. The image forming apparatus according to claim 1, further comprising:
a conveyance roller configured to convey a sheet to the conveyance path,
wherein the image forming unit is further configured to form the image on the sheet conveyed by the conveyance roller, and
the second density calibration is a calibration for adjusting density unevenness in a conveyance direction in which the conveyance roller conveys the sheet.

9. The image forming apparatus according to claim 4, wherein
a resolution of signal values as the second density information is higher than a resolution of signal values as the first density information.

10. The image forming apparatus according to claim 4, wherein
the image forming unit includes an image processing unit that converts an input image signal based on a tone correction condition, and forms the image based on the converted image signal, and
the controller creates the tone correction condition based on the first density information in the first density calibration.

11. The image forming apparatus according to claim 4, wherein
the image forming unit includes an image processing unit that corrects an input image signal based on a correction value, and forms the image based on the corrected input image signal, and
the controller creates the correction value based on the second density information in the second density calibration.
